(19) United States
(12) Patent Application Publication
(10) Pub. No.: US 2026/0361080 A1
(43) Pub. Date: Nov. 12, 2026

(54) POWER SUPPLY BACKUP POWER SYSTEM AND METHOD

(71) Applicant: SUZHOU METABRAIN INTELLIGENT TECHNOLOGY CO., LTD., Suzhou, Jiangsu (CN)

(72) Inventors: Deyang HUA, Suzhou, Jiangsu (CN); An WU, Suzhou, Jiangsu (CN); Lingyan WANG, Suzhou, Jiangsu (CN); Jianyu LI, Suzhou, Jiangsu (CN)

(21) Appl. No.: 19/115,700

(22) PCT Filed: Dec. 15, 2023
(86) PCT No.: PCT/CN2023/139265

§ 371 Date: Mar. 26, 2025

(30) Foreign Application Priority Data
May 17, 2023 (CN) 202310554086.1

(51) Int. Cl. H02J 1/16; H02B 1/20; H02B 1/30; H02J 1/08; H02J 1/102

(52) U.S. Cl. CPC H02J 1/16; H02B 1/202; H02B 1/30; H02J 1/08; H02J 1/102

(57) ABSTRACT

Provided are a power supply backup system and method. The power supply backup system includes a plurality of high-voltage direct-current buses, a centralized energy storage backup system and a power distribution system. The plurality of high-voltage direct-current buses are connected to the power distribution system; the power distribution system is used for connecting to a communication device, and the power distribution system is used for distributing the high-voltage direct current transmitted on the plurality of high-voltage direct-current buses to the communication device; the centralized energy storage backup power system is bypassed on the plurality of high-voltage direct-current buses; the plurality of high-voltage direct-current buses are used for charging the centralized energy storage backup power system under a normal power supply condition; and the centralized energy storage backup power system is used for discharging to a high-voltage direct-current bus having abnormal power supply.

### CROSS-REFERENCE TO RELATED APPLICATION

The present application claims priority to Chinese patent application No. 202310554086.1, entitled “POWER SUPPLY BACKUP POWER SYSTEM AND METHOD”, filed on May 17, 2023 before the China National Intellectual Property Administration, which is incorporated herein in its entirety by reference.

### TECHNICAL FIELD

This application relates to the field of supplying power for communication devices, in particular to a power supply backup system and method.

### BACKGROUND

With the rapid growth of high-performance computing applications such as artificial intelligence, machine learning, and big data mining, centralized computing and storage in data centers are flourishing. To ensure data security, the power supply systems of data centers typically employ a plurality of redundancies to enhance the reliability of the power supply.

In practical applications, the power supply system includes an AC (Alternating Current) bus, an HVDC (High Voltage Direct Current) bus, a first energy storage backup system, and a second energy storage backup system. The AC bus and HVDC bus are used for distributing power to communication devices. The first energy storage backup system is connected to the AC bus and used for backup power of the AC bus. The second energy storage backup system is connected to the HVDC bus and used for backup power of the HVDC bus.

The aforementioned power supply system utilizes the first energy storage backup system and the second energy storage backup system with different structures to achieve dual backup for both the AC bus and the HVDC bus. The high redundancy of the power supply system consequently leads to increased complexity in the networking of the power supply system and higher costs.

### SUMMARY

The objective of this application is to provide a power supply backup system and method to solve the technical problems in the related art. The specific technical solutions are as follows:

A first aspect of the application provides a power supply backup power system, including: a plurality of HVDC buses, a centralized energy storage backup system, and a power distribution system, the plurality of HVDC buses being connected to the power distribution system, the power distribution system is connected to a communication device, and configured to distribute high-voltage DC power transmitted on the plurality of HVDC buses to the communication device;

the centralized energy storage backup system is bypassed across the plurality of HVDC buses, the plurality of HVDC buses are utilized to charge the centralized energy storage backup system during normal power supply, and the centralized energy storage backup system is configured to discharge to a HVDC bus with abnormal power supply among the plurality of HVDC buses.

In some embodiments of the application, the centralized energy storage backup system includes a plurality of bidirectional DC converters I and a first energy storage module connected to the bidirectional DC converters I, each of the bidirectional DC converters I being connected to a respective HVDC bus among the plurality of HVDC buses;

the plurality of HVDC buses are utilized to charge the first energy storage module through the bidirectional DC converters I during normal power supply, and the first energy storage module is configured to discharge to the HVDC bus with abnormal power supply through the bidirectional DC converters I.

In some embodiments of the application, the communication device includes a plurality of power supply units, the power supply units include a plurality of interface circuits arranged in parallel, the plurality of interface circuits are connected to the plurality of HVDC buses through the power distribution system respectively.

In some embodiments of the application, each of the power supply units includes a plurality of DC converters arranged in parallel, and the interface circuits, after being connected in parallel, are connected to input ends of the DC converters.

In some embodiments of the application, the communication device includes a distributed energy storage backup system connected to the power distribution system; the HVDC buses are utilized to charge, through the power distribution system, the distributed energy storage backup system during normal power supply, and the distributed energy storage backup system is configured to discharge to the power distribution system when any of the HVDC buses has abnormal power supply.

In some embodiments of the application, the distributed energy storage backup system includes a plurality of bidirectional DC converters II and a second energy storage module connected to the plurality of bidirectional DC converters II, the plurality of bidirectional DC converters II being connected to the power distribution system;
the HVDC buses are utilized to charge, through the power distribution system and the bidirectional DC converters II, the second energy storage module during normal power supply, and the second energy storage module is configured to discharge to the power distribution system through the bidirectional DC converters II.

In some embodiments of the application, the first energy storage module includes a first high-voltage battery matrix having a plurality of first high-voltage batteries; the HVDC buses are utilized to charge, through the bidirectional DC converters I, the first high-voltage battery matrix during normal power supply, and the first high-voltage battery matrix is configured to discharge to the HVDC bus with abnormal power supply through the bidirectional DC converters I.

In some embodiments of the application, the first energy storage module further includes a first battery management system configured to manage the first high-voltage battery matrix.

In some embodiments of the application, the first energy storage module further includes a first inspection unit configured to inspect whether the first high-voltage batteries in the first high-voltage battery matrix are faulty.

In some embodiments of the application, the bidirectional DC converter I is a bidirectional isolated DC converter I.

In some embodiments of the application, each of the interface circuits includes an equivalent diode circuit, an anode of the equivalent diode circuit being connected to the HVDC bus through the power distribution system, and a cathode of the equivalent diode circuit being connected to the input ends of the DC converters.

In some embodiments of the application, the plurality of HVDC buses include a first HVDC bus and a second HVDC bus; the power distribution system includes a first distributor connected to the first HVDC bus and a second distributor connected to the second HVDC bus; each of the power supply units is connected to both the first distributor and the second distributor.

In some embodiments of the application, the first distributor includes any one of a first power distribution unit, a first current-carrying connector, and a first busbar; the second distributor includes any one of a second power distribution unit, a second current-carrying connector, and a second busbar.

In some embodiments of the application, the power supply backup system further includes a first DC power distribution cabinet and a second DC power distribution cabinet; the first HVDC bus is connected to the first DC power distribution cabinet, then the first DC power distribution cabinet is connected to the first distributor; the second HVDC bus is connected to the second DC power distribution cabinet, then the second DC power distribution cabinet is connected to the second distributor.

In some embodiments of the application, the communication device includes a plurality of distributed energy storage backup systems, each of the plurality of distributed energy storage backup systems being connected to both the first distributor and the second distributor; the distributed energy storage backup systems are configured to discharge to the first distributor when the first HVDC bus has abnormal power supply, and discharge to the second distributor when the second HVDC bus has abnormal power supply.

In some embodiments of the application, the second energy storage module includes a second high-voltage battery matrix having a plurality of second high-voltage batteries; the HVDC buses are utilized to charge, through the bidirectional DC converter II, the second high-voltage battery matrix during normal power supply, and the second high-voltage battery matrix is configured to discharge to the power distribution system through the bidirectional DC converter II.

In some embodiments of the application, the second energy storage module further includes a second battery management system configured to manage the second high-voltage battery matrix.

In some embodiments of the application, the second energy storage module further includes a second inspection unit configured to inspect whether the second high-voltage batteries in the second high-voltage battery matrix are faulty.

In some embodiments of the application, the bidirectional DC converter II is a bidirectional isolated DC converter II.

In some embodiments of the application, a number of centralized energy storage backup systems is greater than or equal to 1, and less than or equal to the number of the HVDC buses, each of the centralized energy storage backup systems is bypassed across the plurality of HVDC buses.

A second aspect of the application provides a power supply and backup method, applied to any of the power supply backup systems described above. The method include:
during normal power supply of the plurality of HVDC buses, controlling the centralized energy storage backup system to be in a charging state, wherein when being in the charging state, the centralized energy storage backup system is charged by the plurality of HVDC buses with normal power supply;
in response to any one of the HVDC buses having abnormal power supply, controlling the centralized energy storage backup system to be in a charging-discharging state, wherein when being in the charging-discharging state, the centralized energy storage backup system discharges power to the HVDC bus having the abnormal power supply.

The power supply backup system provided in this application can achieve backup power for a plurality of HVDC buses by utilizing a single centralized energy storage backup system. When any HVDC bus has abnormal power supply, the centralized energy storage backup system can discharge to the HVDC bus with abnormal power supply. Meanwhile, the HVDC buses with normal power supply continue to charge the centralized energy storage backup system, ensuring that the centralized energy storage backup system can persistently discharge to the HVDC bus with abnormal power supply, thereby guaranteeing the reliability of the power supply backup system. As a result, the power supply backup system provided in this application can achieve, by utilizing a single centralized energy storage backup system, the equivalent reliability obtained by existing systems that require both a first energy storage backup system and a second energy storage backup system. Therefore, the power supply backup system provided in this application has lower redundancy, reducing the complexity and cost of networking the power supply backup system. Moreover, since the power supply backup system provided in this application can achieve, by utilizing a single centralized energy storage backup system, the equivalent reliability obtained by existing systems that require both a first energy storage backup system and a second energy storage backup system, it occupies less space, saving room and avoiding spatial waste. Furthermore, the power supply backup system provided in this application utilizes only HVDC buses with lower transmission losses, eliminating the need for AC buses or hybrid bus architectures. This reduces the variety of equipment required in the system and minimizes energy losses.

### BRIEF DESCRIPTION OF THE DRAWINGS

In order to describe the technical solutions in the application or the related art more clearly, the accompanying drawings required for describing embodiments or the related art will be briefly introduced below.

FIG. 1 is a first schematic structural diagram of a power supply backup system provided by the application;

FIG. 2 is a schematic structural diagram of a centralized energy storage backup system in the power supply backup system provided by the application;

FIG. 3 is a second schematic structural diagram of a power supply backup system provided by the application;

FIG. 4 is a schematic structural diagram of an interface circuit in a power supply unit of the power supply backup system provided by the application;

FIG. 5 is a schematic structural diagram of a DC converter in the power supply unit of the power supply backup system provided by the application;

FIG. 6 is a third schematic structural diagram of a power supply backup system provided by the application;

FIG. 7 is a fourth schematic structural diagram of a power supply backup system provided by the application;

FIG. 8 is a fifth schematic structural diagram of a power supply backup system provided by the application;

FIG. 9 is a schematic structural diagram of a distributed energy storage backup system in the power supply backup system provided by the application; and

FIG. 10 is a flowchart of steps of a power supply and backup method provided by the application.

### REFERENCE SIGNS

11—Interface circuit, 12—Equivalent diode circuit.

### DETAILED DESCRIPTION OF THE EMBODIMENTS

The technical solutions of the application will be described in conjunction with the accompanying drawings below.

The embodiments listed in the disclosure are only used to explain this application, and are not intended to limit the scope of this application. In paragraphs hereinafter, this application is described in more detail by way of example with reference to the accompanying drawings. It should be noted that the figures are drawn in a simplified form with non-precise scales, solely for the purpose of facilitating and clarifying the explanation of the objectives of this application.

With the rapid expansion of traffic volume on the application demand side, the data throughput and data processing density of data centers have increased sharply, leading to a dramatic rise in electricity consumption. However, under the backdrop of dual carbon goals, low PUE (Power Usage Effectiveness, a data center energy consumption evaluation metric), and the coordination of computing power and electricity, the traditional data center's high energy loss issues, power density issues, and reliability issues have become prominent and face significant challenges.

Currently, the first energy storage backup system and the second energy storage backup system in the power supply system have different structures, that is, the types of equipment in the energy storage backup systems are not unified, resulting in higher complexity in networking. The aforementioned power supply system uses the first energy storage backup system and the second energy storage backup system with different structures to achieve dual backup for both AC bus and HVDC bus, leading to high redundancy in the power supply system, which in turn increases the complexity in networking the power supply system and the cost of the power supply system. Moreover, since the first energy storage backup system and the second energy storage backup system are required to achieve dual backup for AC bus and HVDC bus, a large space is occupied, resulting in spatial waste. To address these issues, this application provides a power supply backup system and method, which will be described in detail below.

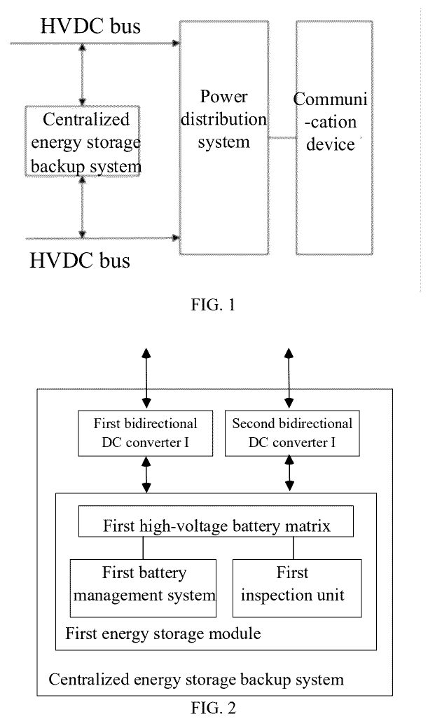

In a first aspect, referring to FIG. 1 to FIG. 9, a power supply backup system provided by this application includes a plurality of high-voltage direct current (HVDC) buses, a centralized energy storage backup system, and a power distribution system. The plurality of HVDC buses are connected to the power distribution system that is connected to a communication device and configured to distribute the high-voltage direct current power transmitted on the plurality of HVDC buses to the communication device. The centralized energy storage backup system is bypassed across the plurality of HVDC buses. Under normal power supply conditions, these HVDC buses are used to charge the centralized energy storage backup system. When any HVDC bus has abnormal power supply, the centralized energy storage backup system discharges power to the HVDC bus with abnormal power supply.

Specifically, the high-voltage direct current bus, also known as the HVDC bus, is used to provide DC power supply, with relatively stable voltage and no directional flip. The voltage range of the HVDC bus includes 48 Vdc and DC voltages higher than 48 Vdc, including but not limited to typical voltage values such as 240 Vdc, 336 Vdc, 380 Vdc, and 400 Vdc. The number of HVDC buses in the power supply backup system provided by this application can be set according to actual needs. The number of HVDC buses can be set as two. In this case, the power supply backup system includes a first HVDC bus and a second HVDC bus. The first high-voltage direct current is transmitted on the first HVDC bus, and the second high-voltage direct current is transmitted on the second HVDC bus. The power distribution system is configured to distribute the first high-voltage direct current transmitted on the first HVDC bus and the second high-voltage direct current transmitted on the second HVDC bus to the communication device. The communication device can include, but is not limited to electronic devices such as a server, a switch, a storage server, and a base station. A plurality of communication devices can form a data center, a database, etc. In this application, the power distribution system can provide a plurality of HVDC bus power distributions for the communication device.

The power distribution system can include, but is not limited to, a power distribution unit (PDU) and its combined forms. The power distribution system not only distributes the high-voltage direct current transmitted on the HVDC buses to various communication devices, but also allocates the high-voltage direct current transmitted to the communication devices to various power-consuming units within each communication device. Different combinations of PDUs can form different power distribution architectures, so as to achieve redundant power supply and backup, dual-bus dual-backup sharing systems, multi-bus heterogeneous backup systems, etc.

The input sources of the HVDC buses may include, but are not limited to, municipal power, oil generators, photovoltaic systems, wind turbines, tidal energy, and geothermal energy. The input sources of the first HVDC bus and the second HVDC bus may be different. The input source of the first HVDC bus may include, but is not limited to, municipal power, oil generators, etc. The input source of the second HVDC bus may be local renewable energy, including but not limited to photovoltaic systems, wind turbines, tidal energy, and geothermal energy.

The number of centralized energy storage backup systems may be set according to actual needs. The number of centralized energy storage backup systems may be set as one. The HVDC buses are all connected to the centralized energy storage backup system, and the electrical connection between the centralized energy storage backup system and the HVDC buses is bidirectional, that is, the HVDC buses can charge the centralized energy storage backup system, and the centralized energy storage backup system can also discharge to the HVDC buses.

Taking a power supply backup power system including the first HVDC bus and the second HVDC bus as an example, if the first HVDC bus has abnormal power supply, such as a fault and power loss, then the centralized energy storage backup system will discharge to the first HVDC bus. Meanwhile, the second HVDC bus with normal power supply will continue to charge the centralized energy storage backup system, so that the centralized energy storage backup system can maintain continuous discharge to the first HVDC bus. At this time, the power supply backup power system provided by this application transitions from dual-source dual-bus power supply to single-source dual-bus power supply. If the second HVDC bus has abnormal power supply, such as a fault and power loss, then the centralized energy storage backup system will discharge to the second HVDC bus. Meanwhile, the first HVDC bus with normal power supply will continue to charge the centralized energy storage backup system, so that the centralized energy storage backup system can maintain continuous discharge to the second HVDC bus. At this time, the power supply backup power system provided by this application transitions from dual-source dual-bus power supply to single-source dual-bus power supply. According to the power supply backup system provided by this application, when either the first HVDC bus or the second HVDC bus experiences a fault and power loss, not only can the centralized energy storage backup system provide backup power to the faulty HVDC bus, but the normal HVDC bus and the centralized energy storage backup system can also enable a transition from dual-source dual-bus power supply to single-source dual-bus power supply.

The power supply backup system provided by this application can provide backup power for a plurality of HVDC buses through a single centralized energy storage backup system. In the event of any HVDC bus has abnormal power supply, the centralized energy storage backup system can discharge power to the abnormal HVDC bus. Meanwhile, the HVDC bus with normal power supply will continue to charge the centralized energy storage backup system, so that the centralized energy storage backup system can maintain continuous discharge to the abnormal HVDC bus, thereby maintaining the reliability of the power supply backup system. Therefore, the power supply backup system provided in this application can achieve the same level of reliability with a single centralized energy storage backup system as that obtained by existing power supply systems that require both a first energy storage backup system and a second energy storage backup system. Thus, the redundancy of the power supply backup system is lower, reducing the complexity and cost of networking the power supply backup system and lowering the design and implementation difficulty for large-scale data center infrastructure. Moreover, since the power supply backup system provided in this application can achieve the same reliability with a single centralized energy storage backup system as that obtained by the existing power supply systems that require the first energy storage backup system and the second energy storage backup system, it occupies less space, saving the space that would otherwise be used by the power supply backup system and avoiding spatial waste. Furthermore, since the power supply backup system provided in this application only employs HVDC buses with lower transmission losses and dispenses with architectures of alternating current (AC) buses and hybrid buses, the types of equipment in the power supply backup system is reduced, reducing the complexity of networking the power supply backup system, and lowering energy losses. By not using AC buses, the power supply backup system eliminates the need for PDUs with isolation functions and PSUs with PFC (Power Factor Correction) that support AC input. Moreover, by only using HVDC buses, the power supply backup system is highly integrated, reducing the redundancy of the power supply backup system, and enhancing the flexibility of the power supply backup system.

Referring to FIG. 2, the centralized energy storage backup system includes a plurality of bidirectional DC converters I and a first energy storage module connected to the plurality of bidirectional DC converters I. The plurality of bidirectional DC converters I are connected to the plurality of HVDC buses respectively. Under normal power supply conditions, the HVDC buses are used to charge the first energy storage module through the bidirectional DC converters I. The first energy storage module is used to discharge power to the anomalous HVDC bus through the bidirectional DC converters I.

Specifically, the bidirectional DC converter I is also known as bidirectional DC-DC converter I. The number of bidirectional DC converters I in the centralized energy storage backup system is the same as the number of the HVDC buses. When the power supply backup system includes two HVDC buses, namely the first HVDC bus and the second HVDC bus, the centralized energy storage backup system includes two bidirectional DC converters I, referred to as a first bidirectional DC converter I and a second bidirectional DC converter I. The first bidirectional DC converter I is connected to the first HVDC bus, and the second bidirectional DC converter I is connected to the second HVDC bus.

The first HVDC bus or the second HVDC bus can charge the first energy storage module through the bidirectional direct current converters I. If the first HVDC bus has abnormal power supply, the first energy storage module will discharge power to the first HVDC bus through the bidirectional DC converter I. Meanwhile, the second HVDC bus with normal power supply continues to charge the first energy storage module through the bidirectional direct current converter I. In this embodiment, the plurality of bidirectional DC converters I can provide backup power for the plurality of HVDC buses, and the bidirectional direct current conversion of the plurality of HVDC buses in the centralized energy storage backup system does not interfere with each other, ensuring the backup performance of the centralized energy storage backup system for the plurality of HVDC buses.

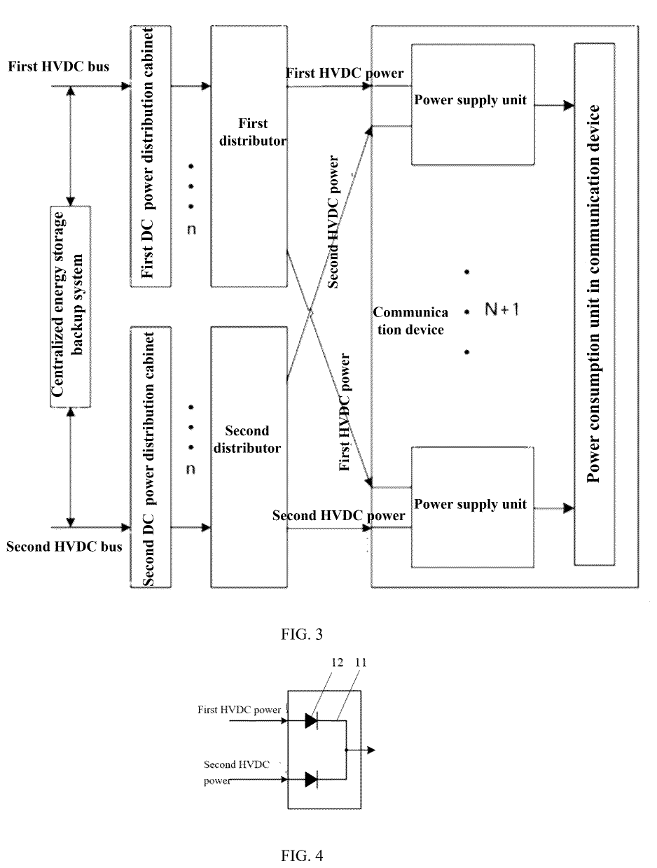

Referring to FIG. 3 to FIG. 4 and FIG. 6 to FIG. 8, the communication device includes a plurality of power supply units, the power supply units include a plurality of interface circuits connected in parallel. The plurality of interface circuits 11 are connected to the plurality of HVDC buses through the power distribution system respectively.

Specifically, the power supply unit (PSU) can be in the form of an independent modular unit or integrated with the motherboard or power board of the communication device. The PSU supports, but is not limited to, HVDC input. The communication device may include (N+1) PSUs, where N is a positive integer greater than or equal to 1. In this case, the PSUs in the communication device adopt an (N+1) redundancy configuration, with the first HVDC bus and the second HVDC bus jointly supplying power to the communication device through (N+1) PSUs. Alternatively, depending on the importance of the communication device, the communication device may include (N+X) PSUs, where X is a positive integer greater than 1. In this case, the PSUs in the communication device adopt an (N+X) redundancy configuration. The number of interface circuits 11 is equal to the number of HVDC buses. When the power supply backup system includes two HVDC buses, namely the first HVDC bus and the second HVDC bus, the PSU includes two interface circuits 11 connected in parallel. In other words, the PSU is a dual-input PSU. Among them, one interface circuit 11 is connected to the first HVDC bus through the power distribution system, and the other interface circuit 11 is connected to the second HVDC bus through the power distribution system.

In this embodiment, when the power supply backup system includes two HVDC buses, namely the first HVDC bus and the second HVDC bus, only (N+1) dual-input PSUs can be used to achieve the same level of reliability as that achieved by existing power supply systems with 2×(N+1) PSUs. The PSU can only support HVDC input, in which case the rectification and boost unit in the PSU can be omitted, thereby enhancing the system's power supply efficiency. In this embodiment, through the aforementioned configuration, the redundancy of the PSUs can be effectively reduced, the number of equipment units in the power supply backup system can be decreased, and costs and space can be saved, while achieving high reliability requirements with low redundancy equipment. If 2×(N+1) redundancy is still used, it will result in doubled high redundancy and high reliability. Additionally, since the input to the PSU is HVDC, the PSU does not require PFC functionality, thereby reducing energy losses.

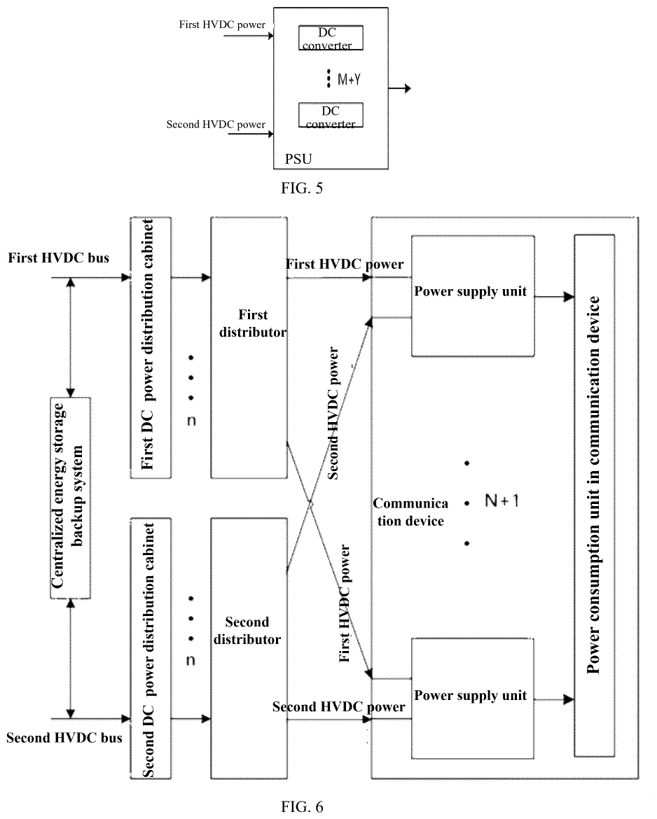

Referring to FIG. 5, the power supply unit includes a plurality of DC converters connected in parallel. A plurality of input interfaces are connected in parallel and then connected to the input end of the DC converters.

Specifically, the number of DC converters in the power supply unit may be set according to the actual load power requirements. The PSU may include (M+1) DC converters connected in parallel, where M is a positive integer greater than or equal to 1. In this case, the DC converters in the PSU adopt an (M+1) redundancy configuration. Alternatively, depending on the importance of the communication device, the PSU may include (M+Y) DC converters connected in parallel, where Y is a positive integer greater than 1. In this case, the DC converters in the PSU adopt an (M+Y) redundancy configuration. The DC converter has an input end and an output end, with the input end connected to the input interface circuit 11. Both the input end and the output end of the DC converter are equipped with a fault disconnection switch, enabling the DC converter to have self-disconnection functionality. In this embodiment, by configuring the PSU to include a plurality of DC converters connected in parallel, the self-redundancy capability of a single PSU is effectively enhanced, improving the power supply redundancy, reliability, and maintainability of the PSU, and achieving flexible power distribution and high efficiency of the PSU.

In summary, the power supply backup system provided by this embodiment has achieved the reliability of high-redundancy, high-reliability power supply systems in existing high-level data centers with low equipment redundancy. Such configuration further enhances the functionality and reliability of the power supply backup system, and further improves the power supply redundancy, reliability, and maintainability of the PSU.

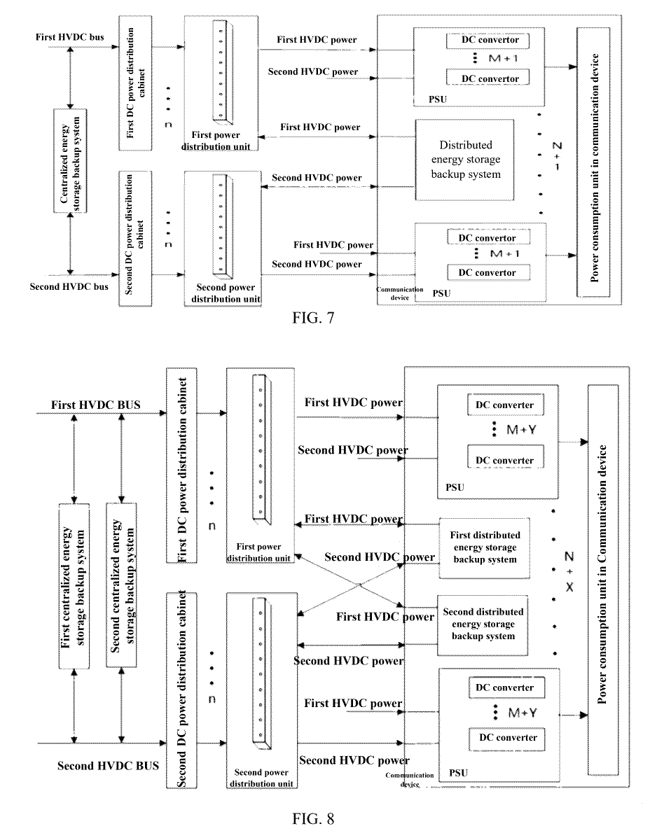

Referring to FIG. 7 and FIG. 8, the communication device includes a distributed energy storage backup system. The distributed energy storage backup system is connected to the power distribution system. The HVDC bus is used to charge the distributed energy storage backup system through the power distribution system during normal power supply. The distributed energy storage backup system is used to discharge power to the power distribution system when any HVDC bus has abnormal power supply.

Specifically, the distributed energy storage backup system in the communication device is optional. The number of distributed energy storage backup systems may be set according to actual needs, and may be one or two. The distributed energy storage backup system is used to provide backup power for the power distribution system. Any HVDC bus is used to charge the distributed energy storage backup system through the power distribution system during normal power supply. When the power supply backup system includes two HVDC buses, namely the first HVDC bus and the second HVDC bus, the power distribution system may include a first distributor connected to the first HVDC bus and a second distributor connected to the second HVDC bus. The PSUs are connected to the first distributor and the second distributor, and the distributed energy storage backup system is connected to the first distributor and the second distributor. The first HVDC bus is used to charge the distributed energy storage backup system through the first distributor during normal power supply, and the second HVDC bus is used to charge the distributed energy storage backup system through the second distributor during normal power supply. The distributed energy storage backup system is used to discharge power to the first distributor when the first HVDC bus has abnormal power supply, and discharge power to the second distributor when the second HVDC bus has abnormal power supply, thereby supplying power to the PSU in the communication device through the second distributor.

If the first HVDC bus has abnormal power supply, the distributed energy storage backup system will discharge power to the first distributor, which then distributes power to the PSU using the discharge from the distributed energy storage backup system. Meanwhile, the second HVDC bus with normal power supply continues to charge the distributed energy storage backup system through the second distributor. In this way, a transition from dual-source dual-bus power supply to single-source dual-bus power supply is achieved, that is, the input of the PSU is changed from dual-bus dual-source input to dual-bus single-source input. In this embodiment, by providing the distributed energy storage backup system, high-reliability, high-safety distributed backup for the communication device is achieved, which further improves the reliability of the power supply backup system. Moreover, since the high-reliability, high-safety distributed backup for the communication device can be achieved by using a single distributed energy storage backup system, such configuration has lower redundancy under the same level of reliability.

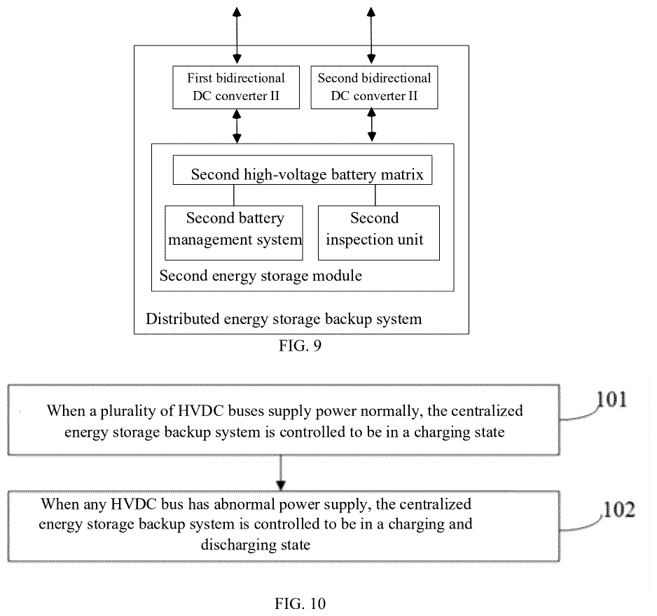

Referring to FIG. 9, the distributed energy storage backup system includes a plurality of bidirectional DC converters II and a second energy storage module connected to the plurality of bidirectional DC converters II. The plurality of bidirectional DC converters II are connected to the power distribution system. The HVDC bus is used to charge the second energy storage module through the power distribution system and the bidirectional DC converters II during normal power supply. The second energy storage module is used to discharge power to the power distribution system through the bidirectional DC converters II.

Specifically, the bidirectional DC converter II is also known as bidirectional DC-DC converter II. The number of the bidirectional DC converters II in the distributed energy storage backup system is the same as the number of the HVDC buses. When the power supply backup system includes two HVDC buses, namely the first HVDC bus and the second HVDC bus, the distributed energy storage backup system includes two bidirectional DC converters II, that is, a first bidirectional DC converter II and a second bidirectional DC converter II. The first bidirectional DC converter II is connected to the first HVDC bus through the power distribution system, and the second bidirectional DC converter II is connected to the second HVDC bus through the power distribution system.

The first HVDC bus or the second HVDC bus can charge the second energy storage module through the power distribution system and the bidirectional DC converters II. If the first HVDC bus has abnormal power supply, the second energy storage module will discharge power to the first distributor connected to the first HVDC bus through the bidirectional DC converter II. Meanwhile, the second HVDC bus with normal power supply continues to charge the second energy storage module through the second distributor and the bidirectional DC converter II. In this embodiment, a plurality of bidirectional DC converters II are used to ensure backup power for the power distribution system, and the bidirectional direct current conversions executed by the plurality of bidirectional DC converters II of the distributed energy storage backup system do not interfere with each other, ensuring the backup performance of the distributed energy storage backup system for the power distribution system.

Referring to FIG. 2, the first energy storage module includes a first high-voltage battery matrix. The first high-voltage battery matrix includes a plurality of first high-voltage batteries. The HVDC bus is used to charge the first high-voltage battery matrix through the bidirectional DC converter I during normal power supply. The first high-voltage battery matrix is used to discharge power to the anomalous HVDC bus through the bidirectional DC converter I.

Specifically, the first high-voltage batteries in the first high-voltage battery matrix can be charged and discharged, in other words, the first high-voltage battery matrix can store and release electrical energy. The electrical energy stored in the first high-voltage battery matrix can provide backup power for the anomalous HVDC bus. The electrical energy stored in the first high-voltage battery matrix is sufficient to ensure the communication device operates normally for a certain duration of emergency repair and maintenance, thereby safeguarding the data security of the communication device. In addition to meeting the emergency repair and maintenance duration for the communication device, the electrical energy stored in the first high-voltage battery matrix can also fulfill the commutation switching time requirements of the bidirectional DC converter I.

Referring to FIG. 2, the first energy storage module further includes a first battery management system configured to manage the first high-voltage battery matrix.

Specifically, in order to enhance the utilization rate of the first high-voltage battery matrix, prevent overcharging and over-discharging of the first high-voltage batteries in the first high-voltage battery matrix, and extend the service life of the first high-voltage battery matrix, the first battery management system (BMS) is configured to collect and analyze data about parameters such as the electrical and thermal characteristics of each first high-voltage battery in the first high-voltage battery matrix, perform state evaluation and management.

Referring to FIG. 2, the first energy storage module further includes a first inspection unit configured to inspect whether various first high-voltage batteries in the first high-voltage battery matrix are faulty. Specifically, in response to detecting a fault in any first high-voltage battery, the first inspection unit will report to facilitate timely maintenance by maintenance personnel, thereby ensuring the reliable operation of the centralized energy storage backup system.

The bidirectional DC converter I includes a bidirectional isolated DC converter I. In this embodiment, the bidirectional isolated DC converter I is used to ensure the safe and stable operation of the centralized energy storage backup system.

Referring to FIG. 4, the interface circuit 11 is provided with an equivalent diode circuit 12. The anode of the equivalent diode circuit 12 is connected to the HVDC bus through the power distribution system, and the cathode of the equivalent diode circuit 12 is connected to the input end of the DC converter.

Specifically, when the power supply backup system includes two HVDC buses, namely the first HVDC bus and the second HVDC bus, the PSU includes two interface circuits 11. Among them, one interface circuit 11 is connected to the first high-voltage DC power transmitted on the first HVDC bus, and the other interface circuit 11 is connected to the second high-voltage DC power transmitted on the second HVDC bus. The equivalent diode circuit 12 includes devices such as diodes. During the operation of the PSU, if the first high-voltage DC power connected to the interface circuit 11 is short-circuited, the diode will be reverse-biased and turn off. That is, the interface circuit 11 connected to the first high-voltage DC power is disconnected, while the other interface circuit 11 connected to the second high-voltage DC power can still operate normally. In other words, when the first or second high-voltage DC power connected to the PSU experiences a short-circuit fault, one interface circuit 11 in the first PSU can still function normally, ensuring the normal operation of the communication device and improving the power supply reliability of the PSU.

Moreover, during the operation of the PSU, when the first or second high-voltage DC power connected to the interface circuit 11 is positive, the diode is turned on, allowing the PSU to operate normally. If the interface circuit 11 is connected to reverse polarity, the diode will not be turned on, thereby achieving the PSU's reverse connection protection function.

Referring to FIG. 3, the plurality of HVDC buses include the first HVDC bus and the second HVDC bus; the power distribution system includes the first distributor connected to the first HVDC bus and the second distributor connected to the second HVDC bus; the power supply units are connected to the first distributor and the second distributor.

Specifically, the first distributor is connected to the first HVDC bus, and allocates the first high-voltage DC power transmitted by the first HVDC bus to the PSUs in the communication device. The second distributor is connected to the second HVDC bus, and allocates the second high-voltage DC power transmitted by the second HVDC bus to the PSUs in the communication device. For each PSU, the two interface circuits 11 thereof are connected to the first second distributor and the second distributor, respectively. In this embodiment, the first distributor and the second distributor are provided to allocate the first high-voltage DC power transmitted from the first HVDC bus and the second high-voltage DC power transmitted from the second HVDC bus to each PSU.

The first distributor includes any one of a first power distribution unit, a first current-carrying connector, and a first busbar. The second distributor includes any one of a second power distribution unit, a second current-carrying connector, and a second busbar.

Specifically, the first power distribution unit is also referred to as the first PDU, and the second power distribution unit is also referred to as the second PDU. In FIG. 6 to FIG. 8, the first distributor adopts the first PDU, and the second distributor adopts the second PDU. The first PDU or the second PDU includes, but is not limited to, a dual-bus combination form to distribute power supply to the communication device. The first PDU or the second PDU may support single-bus, dual-bus, or multi-bus configurations. At this time, one interface circuit 11 of the PSU is connected to the first PDU, and the other interface circuit 11 of the PSU is connected to the second PDU, thereby achieving dual-bus input for the PSU through the first PDU and the second PDU, that is, two PDUs are used to provide dual-bus power distribution for the communication device. The first PDU is specifically connected to the PSU through a first cable, on which the first high-voltage DC power is transmitted. The second PDU is specifically connected to the PSU through a second cable, on which the second high-voltage DC power is transmitted.

The first PDU or the second PDU unit includes, but is not limited to, PDUs with energy metering functions, and PDUs with disconnection protection devices such as circuit breakers. One function of the first PDU or second PDU is to connect the first HVDC bus or the second HVDC bus to the communication device, sharing the HVDC bus. Another function of the first PDU or second PDU is to comply with HVDC-related certification standards. When the first distributor adopts the first current-carrying connector or the first busbar, the first current-carrying connector or the first busbar can be provided as a horizontal or orthogonal architecture. When the second distributor adopts the second current-carrying connector or the second busbar, the second current-carrying connector or the second busbar can be provided as a horizontal or orthogonal architecture.

In this embodiment, the PDUs and the communication device share the HVDC buses. Since the communication device shares the HVDC input, the PDUes can eliminate the isolation transformer, reducing power conversion losses in the main circuit. Additionally, the rectification and power factor correction part at the power supply input side of the communication device is removed, reducing losses in the main and branch circuit converters. The current-carrying losses is reduced by sharing the HVDC bus, effectively lowering energy loss and aligning with low-carbon, green, and energy-saving principles.

Referring to FIG. 3, 6 to 8, the power supply backup system provided in this embodiment further includes a first DC power distribution cabinet and a second DC power distribution cabinet. The first HVDC bus is connected to the first DC power distribution cabinet, and the first DC power distribution cabinet is connected to the first distributor. The second HVDC bus is connected to the second DC power distribution cabinet, and the second DC power distribution cabinet is connected to the second distributor.

Specifically, the first DC power distribution cabinet and the second DC power distribution cabinet are both used for power distribution. The first HVDC bus is connected to the first distributor through the first DC power distribution cabinet, and the second HVDC bus is connected to the second distributor through the second DC power distribution cabinet. The first DC power distribution cabinet may be connected to n first distributors, and the second DC power distribution cabinet may be connected to n second distributors, where n is a positive integer greater than 1. The first HVDC bus and the second HVDC bus supply power to n communication devices through the first DC power distribution cabinet, the second DC power distribution cabinet, n first distributors, and n second distributors.

When the input source of the first HVDC bus is the grid power and the input source of the second HVDC bus is local renewable energy, the first DC power distribution cabinet has grid power distribution and metering functionality, while the second DC power distribution cabinet has renewable energy distribution and metering functionality. This enables the distinction and metering of different energy sources consumed by the communication device, thereby effectively analyzing different energy consumption levels to achieve optimal power system design and configuration.

Referring to FIG. 8, the communication device includes a plurality of distributed energy storage backup systems. Each of the distributed energy storage backup systems is connected to both the first distributor and the second distributor, and is configured to discharge to the first distributor when the first HVDC bus has abnormal power supply and discharge to the second distributor when the second HVDC bus has abnormal power supply.

Specifically, the number of the distributed energy storage backup systems may be two. Referring to FIG. 8, these two distributed energy storage backup systems include a first distributed energy storage backup system and a second distributed energy storage backup system. When the first distributor adopts the first power distribution unit, i.e., the first PDU, and the second distributor adopts the second power distribution unit, i.e., the second PDU, the first HVDC bus is used to charge, during normal power supply, the distributed energy storage backup systems through the first DC power distribution cabinet and the first PDU; the second HVDC bus is used to charge, during normal power supply, the distributed energy storage backup systems through the second DC power distribution cabinet and the second PDU. The first PDU is connected to the distributed energy storage backup system through a third cable, on which the first high-voltage DC power is transmitted. The second PDU is connected to the distributed energy storage backup system through a fourth cable, on which the second high-voltage DC power is transmitted.

If the first HVDC bus has abnormal power supply, the first distributed energy storage backup system will discharge to the first PDU, then the first PDU will use the discharge from the first distributed energy storage backup system to distribute power to the PSU. Meanwhile, the second HVDC bus with normal power supply will continue to charge the second distributed energy storage backup system through the second DC power distribution cabinet and the second PDU. This achieves a transition from dual-source dual-bus power supply to single-source dual-bus power supply, that is, the input of the PSU is transited from dual-bus dual-source input to dual-bus single-source input. In this embodiment, the reliability of the power supply backup system is further enhanced by providing a plurality of distributed energy storage backup systems.

Referring to FIG. 9, the second energy storage module includes a second high-voltage battery matrix including a plurality of second high-voltage batteries. The HVDC bus is used to charge, through the bidirectional DC converters II, the second high-voltage battery matrix during normal power supply. The second high-voltage battery matrix is used to discharge to the power distribution system through the bidirectional DC converters II.

Specifically, various second high-voltage batteries in the second high-voltage battery matrix can be charged and discharged, that is, the second high-voltage battery matrix can store and release electrical energy. The electricity energy stored in the second high-voltage battery matrix can be used to maintain backup power for the distributor connected to the high-voltage DC bus that is abnormal in power supply.

Referring to FIG. 9, the second energy storage module further includes a second battery management system configured to manage the second high-voltage battery matrix.

Specifically, the second battery management system is configured to collect and analyze data about parameters such as the electrical and thermal characteristics of various second high-voltage batteries in the second high-voltage battery matrix, perform state evaluation and management. This enhances the utilization rate of the second high-voltage battery matrix, prevents overcharging and over-discharging of the second high-voltage batteries of the second high-voltage battery matrix, and extends the service life of the second high-voltage battery matrix.

Referring to FIG. 9, the second energy storage module further includes a second inspection unit configured to inspect whether various second high-voltage batteries in the second high-voltage battery matrix is faulty. Specifically, in response to detecting a fault in any second high-voltage battery, the second inspection unit will report to facilitate timely maintenance by maintenance personnel, thereby ensuring the reliable operation of the distributed energy storage backup system.

The bidirectional DC converter II includes a bidirectional isolated DC converter II. In this embodiment, the second bidirectional isolated DC converter II is used to ensure the safe and stable operation of the distributed energy storage backup system.

Referring to FIG. 7 and FIG. 8, the number of the centralized energy storage backup systems is greater than or equal to 1, and less than or equal to the number of HVDC buses. Each centralized energy storage backup system is bypassed across a plurality of HVDC buses.

Specifically, the number of the centralized energy storage backup systems may be one. Referring to FIG. 8, when the number of the HVDC buses is two, two centralized energy storage backup systems, that is, the first centralized energy storage backup system and the second centralized energy storage backup system, may be provided. In this case, both the first centralized energy storage backup system and the second centralized energy storage backup system are bypassed across the first HVDC bus and the second HVDC bus. When two centralized energy storage backup systems are provided, if the first centralized energy storage backup system fails, the second centralized energy storage backup system can still provide backup power for both the first HVDC bus and the second HVDC bus.

In this embodiment, when only one centralized energy storage backup system is provided, the centralized energy storage backup system has no redundancy in the power supply backup system. Compared to the existing dual-redundancy energy storage backup systems, this reduces the redundancy of the power supply backup system, reducing the complexity and cost of networking the power supply backup power system. When two centralized energy storage backup systems are provided, compared to the existing dual-redundancy energy storage backup systems, the reliability of the power supply backup system provided in this application is higher. Moreover, since the structure of the two centralized energy storage backup systems is the same, the complexity of networking the power supply backup power system is reduced.

In a second aspect, referring to FIG. 10, a power supply backup method provided in this application is applied to any one of the power supply backup systems described above. The power supply backup method provided in this application includes steps described below.

At step 101, when a plurality of HVDC buses supply power normally, the centralized energy storage backup system is controlled to be in a charging state.

Specifically, when the centralized energy storage backup system is in a charging state, a plurality of HVDC buses that supply power normally charge the centralized energy storage backup system. The centralized energy storage backup system further includes a control module configured to control the centralized energy storage backup system to be in a charging and discharging state. The centralized energy storage backup system includes a plurality of bidirectional DC converters I and the first energy storage module connected to a plurality of bidirectional DC converters I. When the centralized energy storage backup system is in the charging state, the flow direction of the power for each bidirectional DC converter I is from the HVDC bus to the bidirectional DC converter I and then to the first energy storage module.

At step 102, when any HVDC bus has abnormal power supply, the centralized energy storage backup system is controlled to be in a charging and discharging state.

Specifically, when the centralized energy storage backup system is in a charging and discharging state, it discharges to the HVDC bus with abnormal power supply, while the HVDC bus that supplies power normally continues to charge the centralized energy storage backup system. When the centralized energy storage backup system is in the charging and discharging state, for the bidirectional DC converter I connected to the HVDC bus with abnormal power supply, the flow direction of the power is from the first energy storage module to the bidirectional DC converter I, and then to the HVDC bus with the power supply abnormality. For the bidirectional DC converter I connected to the HVDC bus with normal power supply, the flow direction of the power is from the HVDC bus to the bidirectional DC converter I, and then to the first energy storage module.

In the embodiments of the application, a single centralized energy storage backup system can achieve backup power for a plurality of HVDC buses. When the power supply of any HVDC bus is abnormal, the centralized energy storage backup system can discharge to the HVDC bus with abnormal power supply. At this time, the HVDC bus with normal power supply will continue to charge the centralized energy storage backup system, so that the centralized energy storage backup system can continuously discharge to the HVDC bus with abnormal power supply, thereby ensuring the reliability of the power supply backup system. Therefore, the power supply backup system applied by the power supply backup power method provided in this application can achieve the same reliability obtained by existing power supply systems requiring the first energy storage backup system and the second energy storage backup system, with lower redundancy in the power supply backup system, reducing the networking difficulty and cost of the power supply backup system applied by the power supply backup method.

It should be noted that relational terms herein such as “first” and “second” are used merely to distinguish one entity or operation from another and do not necessarily imply any actual relationship or sequence between these entities or operations. Moreover, the terms “include”, “comprise” or any other variants are intended to cover non-exclusive inclusion. Thus, a process, method, item, or device that includes a series of elements not only includes those elements but also includes other elements not explicitly listed, or inherent elements of such process, method, item, or device. Unless otherwise restricted, an element defined by the phrase “including a . . . ” does not exclude the presence of additional identical elements in the process, method, item, or device that includes the element.

It should be noted that when a component is referred to as being “fixed to” another component, it can be directly on the other component or may also have an intermediate component in between. When a component is considered to be “connected” to another component, it can be directly connected to the other component or may also have an intermediate component in between. When a component is considered to be “mounted on” another component, it can be directly mounted on the other component or may also have an intermediate component in between. The terms “vertical,” “horizontal,” “left,” “right,” and similar expressions used in this document are for illustrative purposes only.

The various embodiments described in this specification are described in a related manner. The same or similar parts between different embodiments can be referred to each other. Each embodiment focuses on the differences from other embodiments. In particular, for system embodiments, since they are basically similar to method embodiments, they are described more simply, and the relevant parts can refer to the description of the method embodiments.

The above is only a preferred embodiment of this application and is not intended to limit the scope of protection of this application. Any modifications, equivalent substitutions, improvements, etc., made within the spirit and principles of this application are included within the scope of protection of this application.

The power supply backup system provided in this application has been introduced in detail above. Specific examples are used to illustrate the principles and implementation methods of this application. The description of the above embodiments is intended to help understand the structure and core ideas of this application. Moreover, those skilled in the art may change specific implementation methods and application scopes based on the ideas of this application. In summary, the contents of this specification should not be construed as limitations to the present application.

1. A power supply backup system, comprising a plurality of high-voltage direct-current (HVDC) buses, a centralized energy storage backup system, and a power distribution system, the plurality of HVDC buses being connected to the power distribution system, wherein the power distribution system is connected to a communication device, and configured to distribute high-voltage DC power transmitted on the plurality of HVDC buses to the communication device;
wherein the centralized energy storage backup system is bypassed across the plurality of HVDC buses, the plurality of HVDC buses are utilized to charge the centralized energy storage backup system during normal power supply, and the centralized energy storage backup system is configured to discharge to a HVDC bus with abnormal power supply among the plurality of HVDC buses.

2. The power supply backup system according to claim 1, wherein the centralized energy storage backup system comprises a plurality of bidirectional DC converters I and a first energy storage module connected to the plurality of bidirectional DC converters I, each of the plurality of bidirectional DC converters I being connected to a respective HVDC bus among the plurality of HVDC buses;
the plurality of HVDC buses are utilized to charge the first energy storage module through the bidirectional DC converters I during normal power supply, and the first energy storage module is configured to discharge to the HVDC bus with abnormal power supply through the bidirectional DC converters I.

3. The power supply backup system according to claims 1, wherein the communication device comprises a plurality of power supply units, each of the power supply units comprises a plurality of interface circuits connected in parallel, the plurality of interface circuits are connected to the plurality of HVDC buses through the power distribution system respectively.

4. The power supply backup system according to claim 3, wherein each of the power supply units comprises a plurality of DC converters arranged in parallel, and the interface circuits, after being connected in parallel, are connected to input ends of the DC converters.

5. The power supply backup system according to claim 3, wherein the communication device comprises a distributed energy storage backup system connected to the power distribution system; the HVDC buses are utilized to charge, through the power distribution system, the distributed energy storage backup system during normal power supply, and the distributed energy storage backup system is configured to discharge to the power distribution system when any of the HVDC buses has abnormal power supply.

6. The power supply backup system according to claim 5, wherein the distributed energy storage backup system comprises a plurality of bidirectional DC converters II and a second energy storage module connected to the plurality of bidirectional DC converters II, the plurality of bidirectional DC converters Il being connected to the power distribution system;
the HVDC buses are utilized to charge, through the power distribution system and the bidirectional DC converters II, the second energy storage module during normal power supply, and the second energy storage module is configured to discharge to the power distribution system through the bidirectional DC converters II.

7. The power supply backup system according to claim 2, wherein the first energy storage module comprises a first high-voltage battery matrix having a plurality of first high-voltage batteries; the HVDC buses are utilized to charge, through the bidirectional DC converters I, the first high-voltage battery matrix during normal power supply, and the first high-voltage battery matrix is configured to discharge to the HVDC bus with abnormal power supply through the bidirectional DC converters I.

8. The power supply backup system according to claim 7, wherein the first energy storage module further comprises a first battery management system configured to manage the first high-voltage battery matrix.

9. The power supply backup system according to claim 7, wherein the first energy storage module further comprises a first inspection unit configured to inspect whether the first high-voltage batteries in the first high-voltage battery matrix are faulty.

10. The power supply backup system according to claim 2, wherein the bidirectional DC converter I is a bidirectional isolated DC converter I.

11. The power supply backup system according to claim 4, wherein each of the interface circuits comprises an equivalent diode circuit, an anode of the equivalent diode circuit being connected to the HVDC bus through the power distribution system, and a cathode of the equivalent diode circuit being connected to the input ends of the DC converters.

12. The power supply backup system according to claim 5, wherein the plurality of HVDC buses comprise a first HVDC bus and a second HVDC bus; the power distribution system comprises a first distributor connected to the first HVDC bus and a second distributor connected to the second HVDC bus; each of the power supply units is connected to both the first distributor and the second distributor.

13. The power supply backup system according to claim 12, wherein the first distributor comprises any one of a first power distribution unit, a first current-carrying connector, and a first busbar; the second distributor comprises any one of a second power distribution unit, a second current-carrying connector, and a second busbar.

14. The power supply backup system according to claim 12, further comprising a first DC power distribution cabinet and a second DC power distribution cabinet; the first HVDC bus is connected to the first DC power distribution cabinet, then the first DC power distribution cabinet is connected to the first distributor; the second HVDC bus is connected to the second DC power distribution cabinet, then the second DC power distribution cabinet is connected to the second distributor.

15. The power supply backup system according to claim 12, wherein the communication device comprises a plurality of distributed energy storage backup systems, each of the plurality of distributed energy storage backup systems being connected to both the first distributor and the second distributor; the distributed energy storage backup systems are configured to discharge to the first distributor when the first HVDC bus has abnormal power supply, and discharge to the second distributor when the second HVDC bus has abnormal power supply.

16. The power supply backup system according to claim 6, wherein the second energy storage module comprises a second high-voltage battery matrix having a plurality of second high-voltage batteries; the HVDC buses are utilized to charge, through the bidirectional DC converter II, the second high-voltage battery matrix during normal power supply, and the second high-voltage battery matrix is configured to discharge to the power distribution system through the bidirectional DC converter II.

17. The power supply backup system according to claim 16, wherein the second energy storage module further comprises a second battery management system configured to manage the second high-voltage battery matrix.

18. The power supply backup system according to claim 16, wherein the second energy storage module further comprises a second inspection unit configured to inspect whether the second high-voltage batteries in the second high-voltage battery matrix are faulty.

19. (canceled)

20. The power supply backup system according to claim 1, wherein the power supply backup system comprises a plurality of centralized energy storage backup systems, a number of the centralized energy storage backup systems is greater than or equal to 1, and less than or equal to the number of the HVDC buses, each of the centralized energy storage backup systems is bypassed across the plurality of HVDC buses.

21. A power supply backup method, applied to the power supply backup system according to claim 1, comprising:
during normal power supply of the plurality of HVDC buses, controlling the centralized energy storage backup system to be in a charging state, wherein when being in the charging state, the centralized energy storage backup system is charged by the plurality of HVDC buses with normal power supply;
in response to any one of the HVDC buses having abnormal power supply, controlling the centralized energy storage backup system to be in a charging-discharging state, wherein when being in the charging-discharging state, the centralized energy storage backup system discharges power to the HVDC bus having the abnormal power supply.
